(19) United States
(12) Patent Application Publication
(10) Pub. No.: US 2012/0268707 A1
(43) Pub. Date: Oct. 25, 2012

(54) LIQUID CRYSTAL DISPLAY DEVICE

(75) Inventors: Yuki Yamashita, Osaka-shi (JP); Akihiro Shohraku, Osaka-shi (JP)

(73) Assignee: SHARP KABUSHIKI KAISHA, Osaka-shi, Osaka (JP)

(21) Appl. No.: 13/517,396

(22) PCT Filed: Dec. 21, 2010
(86) PCT No.: PCT/JP2010/073008

§ 371 Date: Jun. 20, 2012

(30) Foreign Application Priority Data
Dec. 24, 2009 (JP) 2009-293110

(51) Int. Cl. G02F 1/1343

(52) U.S. Cl. 349/143

(57) ABSTRACT

In the liquid crystal display device (100) of the present invention, each picture element (P) includes first, second, third and fourth pixels (R, G, B, Y) that represent mutually different colors. The first and second pixels (R, B) are arranged alternately in each odd-numbered column of pixels. The third and fourth pixels (G, Y) are arranged alternately in each even-numbered column of pixels. The first and second pixels (R, B) belong to odd- and even-numbered rows, respectively, in a (4n+1)^{th} column of pixels (PC₄ₙ₊₁), the third and fourth pixels (G, Y) belong to odd- and even-numbered rows, respectively, in a (4n+2)^{th} column of pixels (PC₄ₙ₊₂) the second and first pixels (B, R) belong to odd- and even-numbered rows, respectively, in a (4n+3)^{th} column of pixels (PC₄ₙ₊₃), and the fourth and third pixels (Y, G) belong to odd- and even-numbered rows, respectively, in a (4n+4)^{th} column of pixels (PC₄ₙ₊₄).

### TECHNICAL FIELD

The present invention relates to a liquid crystal display device and more particularly relates to a liquid crystal display device that conducts a display operation in colors by using four or more kinds of pixels that display mutually different colors.

### BACKGROUND ART

Liquid crystal display devices are currently used in a variety of applications. In a general liquid crystal display device, one picture element is comprised of three pixels respectively representing red, green and blue, which are the three primary colors of light, thereby conducting a display operation in colors.

The general liquid crystal display device, however, can reproduce colors that fall within only a narrow range (which is usually called a “color reproduction range”), which is a problem. Thus, to broaden the color reproduction range of liquid crystal display devices, a technique for increasing the number of primary colors for use to perform a display operation has recently been proposed.

For example, Patent Document No. 1 discloses a liquid crystal display device 800 in which one picture element P is made up of four pixels that include not only red, green and blue pixels R, G and B representing the colors red, green and blue, respectively, but also a yellow pixel Y representing the color yellow as shown in FIG. 9. That liquid crystal display device 800 performs a display operation in colors by mixing together the four primary colors red, green, blue and yellow that are represented by those four pixels R, G, B and Y.

By performing a display operation using four or more primary colors, the color reproduction range can be broadened compared to the known liquid crystal display device that uses only the three primary colors for display purposes. Such a liquid crystal display device that conducts a display operation using four or more primary colors will be referred to herein as a “multi-primary-color liquid crystal display device”. And a liquid crystal display device that conducts a display operation using the three primary colors will be referred to herein as a “three-primary-color liquid crystal display device”.

On the other hand, Patent Document No. 2 discloses a liquid crystal display device 900 in which one picture element P is made up of four pixels that include not only red, green and blue pixels R, G and B but also a white pixel W representing the color white as shown in FIG. 10. As the pixel added is a white pixel W, that liquid crystal display device 900 cannot broaden the color reproduction range but can still increase the display luminance.

### CITATION LIST

### Patent Literature

Patent Document No. 1: PCT International Application Publication No. 2007/148519
Patent Document No. 2: Japanese Laid-Open Patent Publication No. 11-295717

### SUMMARY OF INVENTION

### Technical Problem

However, if one picture element P is made up of four pixels as in the liquid crystal display devices 800 and 900 shown in FIGS. 9 and 10, a so-called “horizontal shadow” phenomenon will arise and debase the display quality when a dot inversion drive operation is carried out. The dot inversion drive is a technique for minimizing the occurrence of a flicker on the display screen and is a driving method in which the polarity of the applied voltage is inverted on a pixel-by-pixel basis.

FIG. 11 shows the polarities of voltages applied to respective pixels when a dot inversion drive operation is carried out on a three-primary-color liquid crystal display device. On the other hand, FIGS. 12 and 13 show the polarities of voltages applied to respective pixels when a dot inversion drive operation is carried out on the liquid crystal display devices 800 and 900, respectively.

In a three-primary-color liquid crystal display device, the polarities of the voltages applied to pixels in the same color invert in the row direction as shown in FIG. 11. For example, in the first row of pixels shown in FIG. 11, the voltages applied to the red pixels R go positive (+), negative (−) and positive (+) in this order from the left to the right. The voltages applied to the green pixels G go negative (−), positive (+) and negative (−) in this order. And the voltages applied to the blue pixels B go positive (+), negative (−) and positive (+) in this order.

In the liquid crystal display devices 800 and 900, on the other hand, each picture element P is made up of four pixels. That is why in each and every row of pixels, the voltages applied to pixels in the same color have the same polarity everywhere as shown in FIGS. 12 and 13. For example, in the first row of pixels shown in FIG. 12, the polarity of the voltage applied to every red pixel R is positive (+) and that of the voltage applied to every green pixel G is negative (−). Meanwhile, in the second row of pixels, the polarity of the voltage applied to every blue pixel B is negative (−) and that of the voltage applied to every yellow pixel Y is positive (+). And in the first row of pixels shown in FIG. 13, the polarities of the voltages applied to every red pixel R and every blue pixel B are positive (+) and those of the voltages applied to every green pixel G and every white pixel W are negative (−).

If the voltages applied to pixels in the same color come to have the same polarity anywhere in the row direction in this manner, a horizontal shadow will be cast when a window pattern is displayed in a single color. Hereinafter, it will be described with reference to FIG. 14 why such a horizontal shadow is cast.

As shown in FIG. 14(a), when a high-luminance window WD is displayed on a low-luminance background BG, horizontal shadows SD, which have a higher luminance than the background to be displayed originally, are sometimes cast on the right- and left-hand sides of the window WD.

FIG. 14(b) illustrates an equivalent circuit of a portion of a general liquid crystal display device that covers two pixels. As shown in FIG. 14(b), each of these pixels has a thin-film transistor (TFT) 14. A scan line 12, a signal line 13 and a pixel electrode 11 are respectively electrically connected to the gate, source and drain electrodes of the TFT 14.

A liquid crystal capacitor C_{LC} is formed by the pixel electrode 11, a counter electrode 21 that is arranged to face the pixel electrode 11, and a liquid crystal layer that is interposed between the pixel electrode 11 and the counter electrode 21. Meanwhile, a storage capacitor C_{CS} is formed by a storage capacitor electrode 17 that is electrically connected to the pixel electrode 11, a storage capacitor counter electrode 15a that is arranged to face the storage capacitor electrode 17, and a dielectric layer (i.e., an insulating film) interposed between the storage capacitor electrode 17 and the storage capacitor counter electrode 15a.

The storage capacitor counter electrode 15a is electrically connected to a storage capacitor line 15 and supplied with a storage capacitor counter voltage (CS voltage). FIGS. 14(c) and 14(d) show how the CS voltage and the gate voltage change with time. It should be noted that write voltages (i.e., grayscale voltages applied to the pixel electrode 11 through the signal line 13) have mutually different polarities in FIGS. 14(c) and 14(d).

When the gate voltage goes high to start charging a pixel, the potential of the pixel electrode 11 (i.e., its drain voltage) changes. In the meantime, a ripple voltage is superposed on the CS voltage by way of a parasitic capacitor between the drain and the CS as shown in FIGS. 14(c) and 14(d). As can be seen by comparing FIGS. 14(c) and 14(d), the polarity of the ripple voltage inverts according to that of the write voltage.

The ripple voltage superposed on the CS voltage attenuates with time. If the write voltage has small amplitude (i.e., when the write voltage is applied to pixels that display the background BG), the ripple voltage goes substantially zero when the gate voltage goes low. On the other hand, if the write voltage has large amplitude (i.e., when the write voltage is applied to pixels that display the window WD), the ripple voltage becomes relatively high compared to those pixels that display the background BG. As a result, as shown in FIGS. 14(c) and 14(d), even when the gate voltage goes low, the ripple voltage superposed on the CS voltage has not quite attenuated yet. That is to say, even after the gate voltage has gone low, the ripple voltage continues to attenuate. Consequently, due to that residual ripple voltage Vα, the drain voltage (i.e., the pixel electrode potential) affected by the CS voltage varies from its original level.

With respect to the same row of pixels, two ripple voltages of opposite polarities work to cancel each other, but two ripple voltages of the same polarity will superpose one upon the other. That is why if the voltages applied to pixels in the same color come to have the same polarity everywhere in the row direction as shown in FIGS. 12 and 13, horizontal shadows will be cast when a window pattern is displayed in a single color.

In order to overcome the problem described above, the present invention has been made to prevent such horizontal shadows, which are cast when a dot inversion drive operation is carried out, from debasing the display quality of a liquid crystal display device, of which each picture element is defined by four pixels.

### Solution to Problem

A liquid crystal display device according to the present invention includes a plurality of pixels that are arranged in columns and rows to form a matrix pattern. The device includes: an active-matrix substrate that includes pixel electrodes that are provided for the respective pixels, switching elements that are electrically connected to the pixel electrodes, a plurality of scan lines that run in a row direction, and a plurality of signal lines that run in a column direction; a counter substrate that faces the active-matrix substrate; and a liquid crystal layer that is interposed between the active-matrix substrate and the counter substrate. The plurality of pixels includes first, second, third and fourth pixels that represent mutually different colors. The first and second pixels are arranged alternately in each odd-numbered column of pixels. The third and fourth pixels are arranged alternately in each even-numbered column of pixels. If n is an integer that is equal to or greater than zero, the first and second pixels belong to odd- and even-numbered rows, respectively, in a (4n+1)^{th} column of pixels, the third and fourth pixels belong to odd- and even-numbered rows, respectively, in a (4n+2)^{th} column of pixels, the second and first pixels belong to odd- and even-numbered rows, respectively, in a (4n+3)^{th} column of pixels, and the fourth and third pixels belong to odd- and even-numbered rows, respectively, in a (4n+4)^{th} column of pixels.

In one preferred embodiment, each of the first, second, third and fourth pixels is one of red, green, blue, and yellow pixels that represent the colors red, green, blue, and yellow, respectively.

In one preferred embodiment, the plurality of pixels forms p rows of pixels and q columns of pixels, the plurality of scan lines is comprised of p scan lines, the plurality of signal lines is comprised of q signal lines, and the active-matrix substrate further includes p storage capacitor lines that run in the row direction.

In one preferred embodiment, the plurality of pixels forms p rows of pixels and q columns of pixels, the plurality of scan lines is comprised of (p/2) scan lines, the plurality of signal lines is comprised of 2q signal lines, and the active-matrix substrate further includes (p/2+1) storage capacitor lines that run in the row direction.

In one preferred embodiment, if m is an integer that is equal to or greater than zero, the switching elements of pixels that form a (2m+1)^{th} row of pixels and the switching elements of pixels that form a (2m+2)^{th} row of pixels are electrically connected in common to the same scan line. In each column of pixels, the switching element of each pixel that belongs to an odd-numbered row and the switching element of each pixel that belongs to an even-numbered row are electrically connected to mutually different signal lines. The pixel that belongs to the (2m+2)^{th} row of pixels and the pixel that belongs to the (2m+3)^{th} row of pixels are supplied with a voltage through the same storage capacitor line.

In one preferred embodiment, the plurality of pixels is driven by dot inversion drive method.

### Advantageous Effects of Invention

According to the present invention, it is possible to prevent horizontal shadows, which are cast when a dot inversion drive operation is carried out, from debasing the display quality of a liquid crystal display device, of which each picture element is defined by four pixels.

### BRIEF DESCRIPTION OF DRAWINGS

FIG. 1 A diagram schematically illustrating a liquid crystal display device 100 as a preferred embodiment of the present invention.

FIG. 2 A cross-sectional view schematically illustrating a cross section of one pixel of the liquid crystal display device 100 according to the preferred embodiment of the present invention as viewed in the row direction.

FIG. 3 An equivalent circuit diagram schematically illustrating ten pixels that are arranged in two rows and five columns in the liquid crystal display device 100 according to the preferred embodiment of the present invention.

FIG. 4 A diagram showing the polarities of the voltages applied to the respective pixels of the liquid crystal display device 100 according to the preferred embodiment of the present invention when those pixels are driven by dot inversion drive method.

FIG. 5 A diagram schematically illustrating a liquid crystal display device 100 according to the preferred embodiment of the present invention.

FIG. 6 An equivalent circuit diagram schematically illustrating twenty-four pixels that are arranged in four rows and six columns in a liquid crystal display device 200 as another preferred embodiment of the present invention.

FIG. 7 A diagram showing the polarities of the voltages applied to the respective pixels of the liquid crystal display device 200 according to the preferred embodiment of the present invention when those pixels are driven by dot inversion drive method.

FIG. 8 A diagram schematically illustrating a liquid crystal display device 300 as another preferred embodiment of the present invention.

FIG. 9 A diagram schematically illustrating a known liquid crystal display device 800.

FIG. 10 A diagram schematically illustrating another known liquid crystal display device 900.

FIG. 11 A diagram showing the polarities of voltages applied to respective pixels when a dot inversion drive operation is carried out on a three-primary-color liquid crystal display device.

FIG. 12 A diagram showing the polarities of voltages applied to respective pixels when a dot inversion drive operation is carried out on the known liquid crystal display device 800.

FIG. 13 A diagram showing the polarities of voltages applied to respective pixels when a dot inversion drive operation is carried out on the known liquid crystal display device 900.

FIG. 14 (a) to (d) show why horizontal shadows are cast.

### DESCRIPTION OF EMBODIMENTS

Hereinafter, embodiments of the present invention will be described with reference to the accompanying drawings. It should be noted, however, that the present invention is in no way limited to the embodiments to be described below.

### Embodiment 1

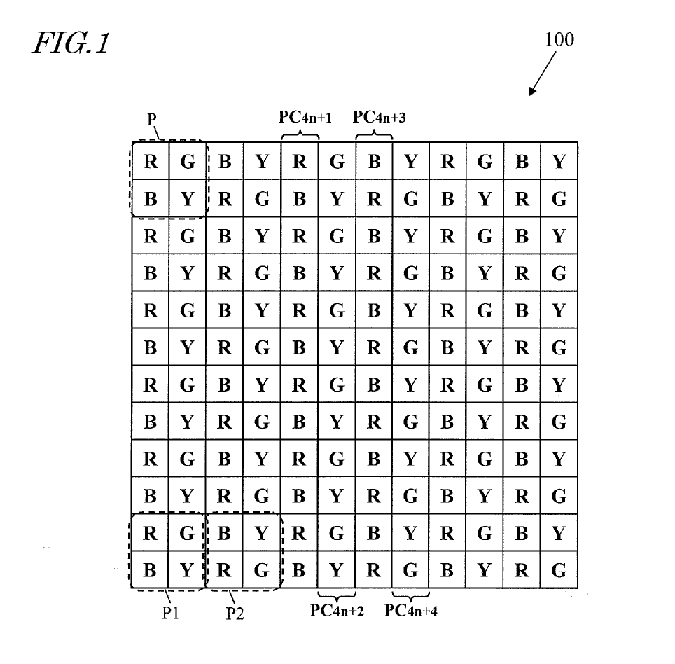

FIG. 1 illustrates a liquid crystal display device 100 as a first embodiment of the present invention. As Shown in FIG. 1, the liquid crystal display device 100 includes a plurality of pixels that are arranged in columns and rows to form a matrix pattern.

The pixels of this liquid crystal display device 100 include four kinds of pixels that represent mutually different colors. Specifically, the pixels include red, green, blue, and yellow pixels R, G, B and Y representing the colors red, green, blue, and yellow, respectively.

One picture element P, which is the minimum unit to conduct a display operation in colors, is defined by these four pixels that are red, green, blue, and yellow pixels R, G, B and Y). In each picture element P, those four pixels are arranged in two columns and two rows to form a matrix pattern.

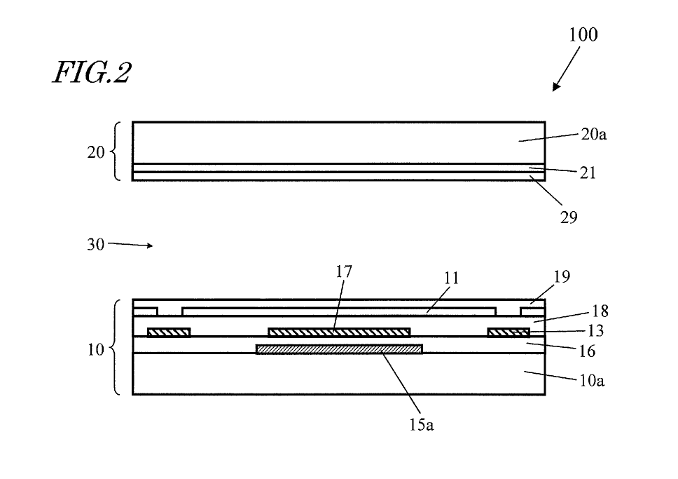

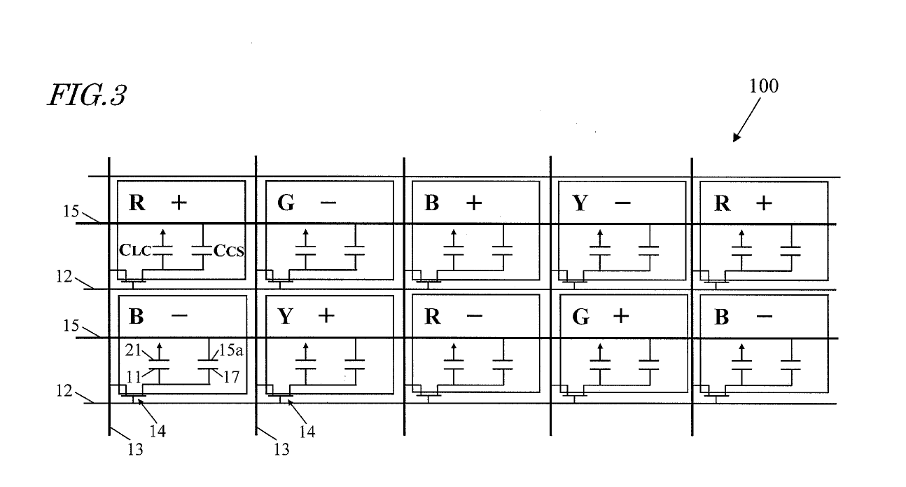

FIGS. 2 and 3 illustrate a specific structure for the liquid crystal display device 100. Specifically, FIG. 2 is a cross-sectional view schematically illustrating a cross section of one pixel of the liquid crystal display device 100 as viewed in the row direction. FIG. 3 is an equivalent circuit diagram illustrating ten pixels that are arranged in two rows and five columns.

As shown in FIG. 2, the liquid crystal display device 100 includes an active-matrix substrate 10, a counter substrate 20 that faces the active-matrix substrate 10, and a liquid crystal layer 30 that is interposed between the active-matrix substrate 10 and the counter substrate 20.

The active-matrix substrate 10 includes pixel electrodes 11, each of which is provided for an associated one of the pixels, thin-film transistors (TFTs) 14 that are electrically connected to the pixel electrodes 11, a plurality of scan lines 12 that run in the row direction, and a plurality of signal lines 13 that run in the column direction. Each TFT 14 functioning as a switching element is supplied with not only a scan signal from its associated scan line 12 but also a display signal from its associated signal line 13.

The scan lines 12 are arranged on a transparent substrate (e.g., a glass substrate) 10a with electrically insulating properties. On the transparent substrate 10a, also arranged is a storage capacitor line 15 that runs in the row direction. The storage capacitor line 15 and the scan lines 12 are made of the same conductor film. A portion 15a of the storage capacitor line 15 that is located near the center of each pixel has a broader width than the rest of the line 15 and functions as a storage capacitor counter electrode. The storage capacitor counter electrode 15a is supplied with a storage capacitor counter voltage (CS voltage) from the storage capacitor line 15.

A gate insulating film 16 is arranged to cover the scan lines 12 and the storage capacitor lines 15 (including the storage capacitor counter electrode 15a). On the gate insulating film 16, arranged are not only the signal lines 13 but also storage capacitor electrodes 17, which are made of the same conductor film as the signal lines 13. Also, each of the storage capacitor electrodes 17 is electrically connected to the drain electrode of its associated TFT 14 and is supplied with the same voltage as its associated pixel electrode 11 via the TFT 14.

An interlayer insulating film 18 is arranged to cover the signal lines 13 and the storage capacitor electrodes 17. The pixel electrodes 11 are located on the interlayer insulating film 18. In the configuration shown in FIG. 2, the pixel electrodes 11 are arranged so that their edges overlap with the scan lines 12 and the signal lines 13 with the interlayer insulating film 18 interposed between them. Naturally, however, the pixel electrodes 11 may also be arranged so that their edges do not overlap with the scan lines 12 or the signal lines 13 at all.

The counter substrate 20 includes a counter electrode 21, which faces the pixel electrodes 11 and which is arranged on a transparent substrate (such as a glass substrate) 20a with electrically insulating properties. Although not shown in any of the drawings, the counter substrate 20 typically further includes a color filter layer and an opaque layer (i.e., a black matrix).

The liquid crystal layer 30 includes liquid crystal molecules (not shown) that have either positive or negative dielectric anisotropy depending on the mode of display, and a chiral agent as needed. Alignment films 19 and 29 are arranged on the uppermost surface (i.e., the surface that is closest to the liquid crystal layer 30) of the active-matrix substrate 10 and counter substrate 20, respectively. Depending on the display mode, the alignment film 19, 29 may be either a horizontal alignment film or a vertical alignment film.

In the liquid crystal display device 100 with such a structure, a liquid crystal capacitor C_{LC} is formed by the pixel electrode 11, the counter electrode 21 that faces the pixel electrode 11, and the liquid crystal layer 30 interposed between them. Also, a storage capacitor C_{CS} is formed by the storage capacitor electrode 17, the storage capacitor counter electrode 15a that faces the storage capacitor electrode 17, and the gate insulating film 16 interposed between them. And a pixel capacitor is formed by the liquid crystal capacitor C_{LC} and the storage capacitor C_{CS} that is arranged in parallel to the liquid crystal capacitor C_{LC}. It should be noted that the storage capacitor C_{CS} does not have to be the illustrated one. For example, if the interlayer insulating film 18 is relatively thin, the storage capacitor electrode 17 may be omitted and the storage capacitor C_{CS} may be formed by the pixel electrode 11, the storage capacitor counter electrode 15a and the gate insulating film 16 and interlayer insulating film 18 that are arranged between them.

The liquid crystal display device 100 of this embodiment has quite a different pixel arrangement from the known one. Hereinafter, the pixel arrangement of this liquid crystal display device 100 will be described with reference to FIGS. 1 and 3.

In this liquid crystal display device 100, red and blue pixels R and B are alternately arranged in each odd-numbered column of pixels and green and yellow pixels G and Y are alternately arranged in each even-numbered column of pixels as shown in FIGS. 1 and 3. That is to say, each column of pixels is comprised of only two out of the four kinds of pixels, and one type of pixel columns, each consisting of two kinds of pixels, alternate with the other type of pixel columns, each consisting of the other two kinds of pixels.

Nevertheless it does not mean that the arrangement of the red and blue pixels R and B is the same in every odd-numbered column of pixels. Specifically, if n is an integer that is equal to or greater than zero, the red pixels R are arranged in the odd-numbered rows and the blue pixels B are arranged in the even-numbered rows in each (4n+1)^{th} column of pixels PC₄ₙ₊₁ (i.e., the first, fifth, ninth, . . . columns of pixels). On the other hand, the blue pixels B are arranged in the odd-numbered rows and the red pixels R are arranged in the even-numbered rows in each (4n+3)^{th} column of pixels PC₄ₙ₊₃ (i.e., the third, seventh, eleventh, . . . columns of pixels). Consequently, there is a shift of one pixel between the pixel arrangements of the (4n+1)^{th} and (4n+3)^{th} columns of pixels PC₄ₙ₊₁ and PC₄ₙ₊₃.

It does not mean that the arrangement of the green and yellow pixels G and Y is the same in every even-numbered column of pixels, either. Specifically, the green pixels G are arranged in the odd-numbered rows and the yellow pixels Y are arranged in the even-numbered rows in each (4n+2)^{th} column of pixels PC₄ₙ₊₂ (i.e., the second, sixth, tenth, . . . columns of pixels). On the other hand, the yellow pixels Y are arranged in the odd-numbered rows and the green pixels G are arranged in the even-numbered rows in each (4n+4)^{th} column of pixels PC₄ₙ₊₄ (i.e., the fourth, eighth, twelfth, . . . columns of pixels). Consequently, there is a shift of one pixel between the pixel arrangements of the (4n+2)^{th} and (4n+4)^{th} columns of pixels PC₄ₙ₊₂ and PC₄ₙ₊₄.

The plurality of pixels is arranged in such a pattern. That is why when attention is paid to two picture elements P1 and P2 that are adjacent to each other in the row direction (see FIG. 1), it can be seen that the red and green pixels R and G are located in the upper half of one picture element P1 and the blue and yellow pixels B and Y are located in the lower half thereof, while the blue and yellow pixels B and Y are located in the upper half of the other picture element P2 and the red and green pixels R and G are located in the lower half thereof. That is to say, these two picture elements P1 and P2 that are adjacent to each other in the row direction have vertically inverted pixel arrangements (i.e., inverted in the column direction).

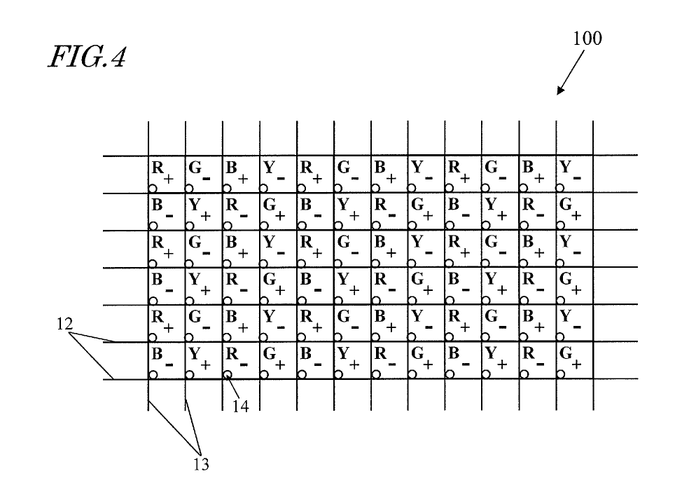

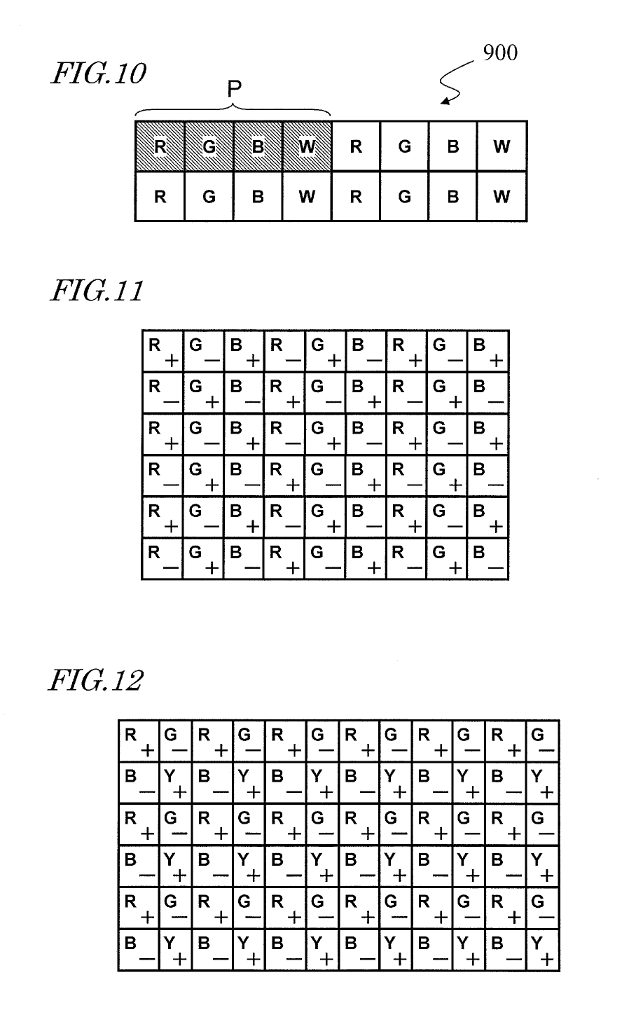

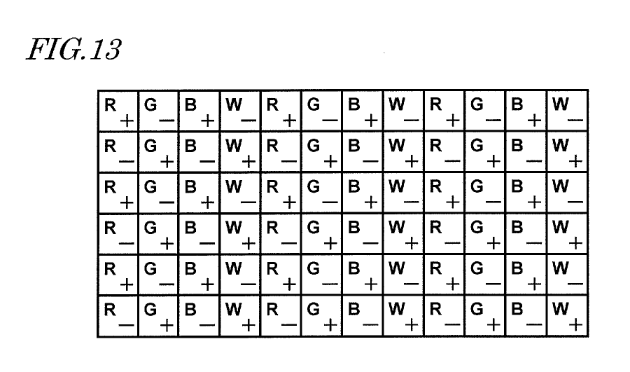

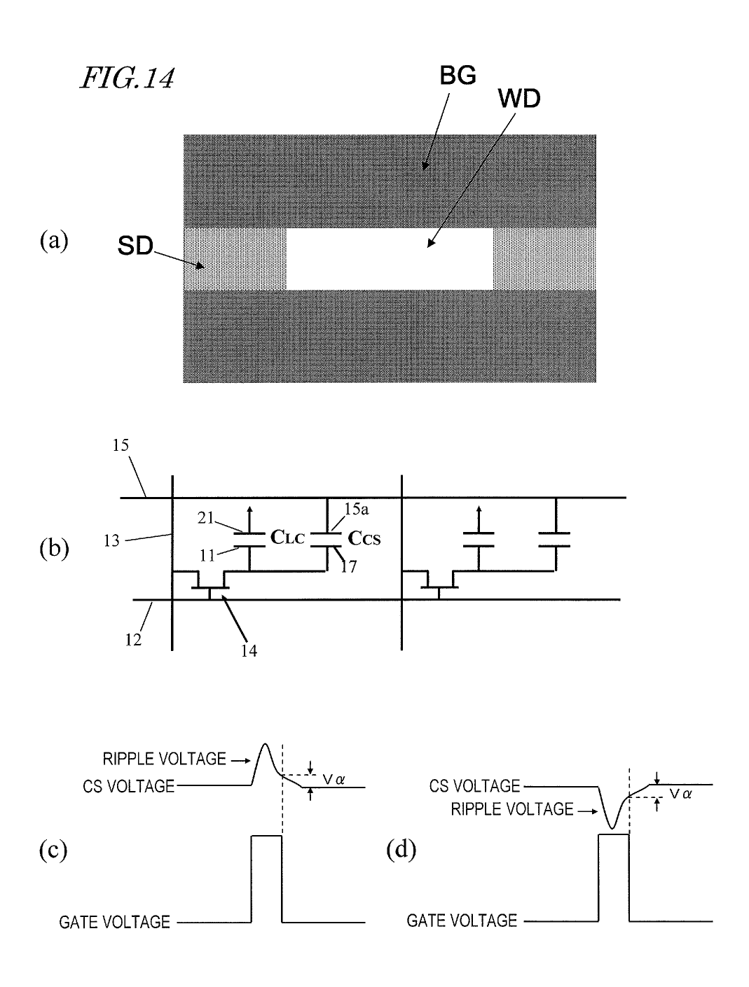

FIG. 4 shows the polarities of the voltages applied to the respective pixels of the liquid crystal display device 100 (i.e., grayscale voltages applied to their pixel electrodes 11) when those pixels are driven by dot inversion drive method. See also FIG. 3, which indicates some of those polarities, too. Comparing FIG. 4 to FIG. 12, it can be seen that the number of pixels in the same color per row of pixels (i.e., the number of pixels in the same color to be supplied with a CS voltage through a single storage capacitor line 15) in the liquid crystal display device 100 of this embodiment is a half as large as in the known liquid crystal display device 800. That is why when the dot inversion drive is carried out, the number of pixels in the same color that come to have the same polarity in the liquid crystal display device 100 is also a half as large as in the known liquid crystal display device 800. For example, in the liquid crystal display device 800 shown in FIG. 12, in a row of pixels including red pixels R, the red pixel R appears every two columns. On the other hand, in the liquid crystal display device 100 shown in FIG. 4, in a row of pixels including red pixels R, the red pixel R appears every four columns.

As described above, in the liquid crystal display device 100 of this embodiment, the number of pixels in the same color that come to have the same polarity when subjected to the dot inversion drive can be halved, and therefore, the horizontal shadows can be reduced. As a result, the degradation in display quality due to such horizontal shadows can be minimized.

FIGS. 1, 3 and 4 illustrate a situation where the red, green, blue, and yellow pixels R, G, B and Y all have the same size. However, this is just an example of the present invention. Optionally, the plurality of pixels that defines each picture element P may include some pixels that have a different size from the others. For example, the red and blue pixels R and B may be larger than the green and yellow pixels G and Y as shown in FIG. 5. If the red pixel R is larger than the yellow pixel Y, a brighter color red (i.e., a color red with higher lightness) can be displayed than in a situation where every pixel has the same size as disclosed in Patent Document No. 1.

### Embodiment 2

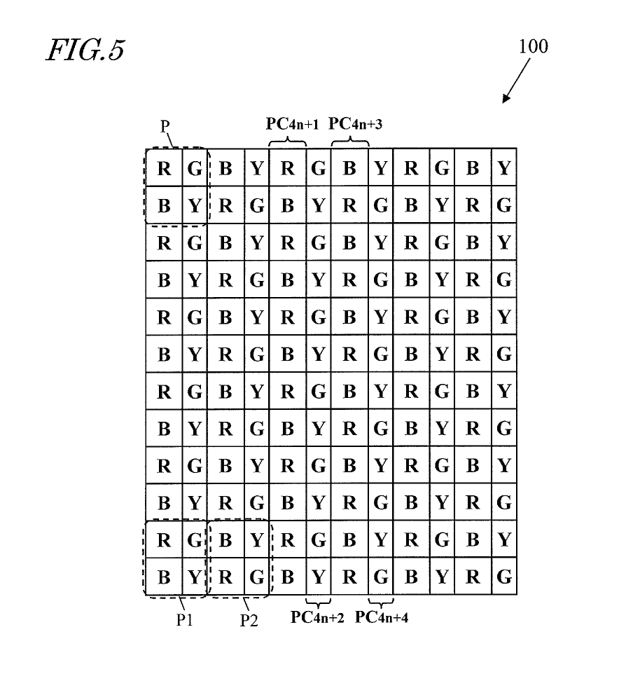

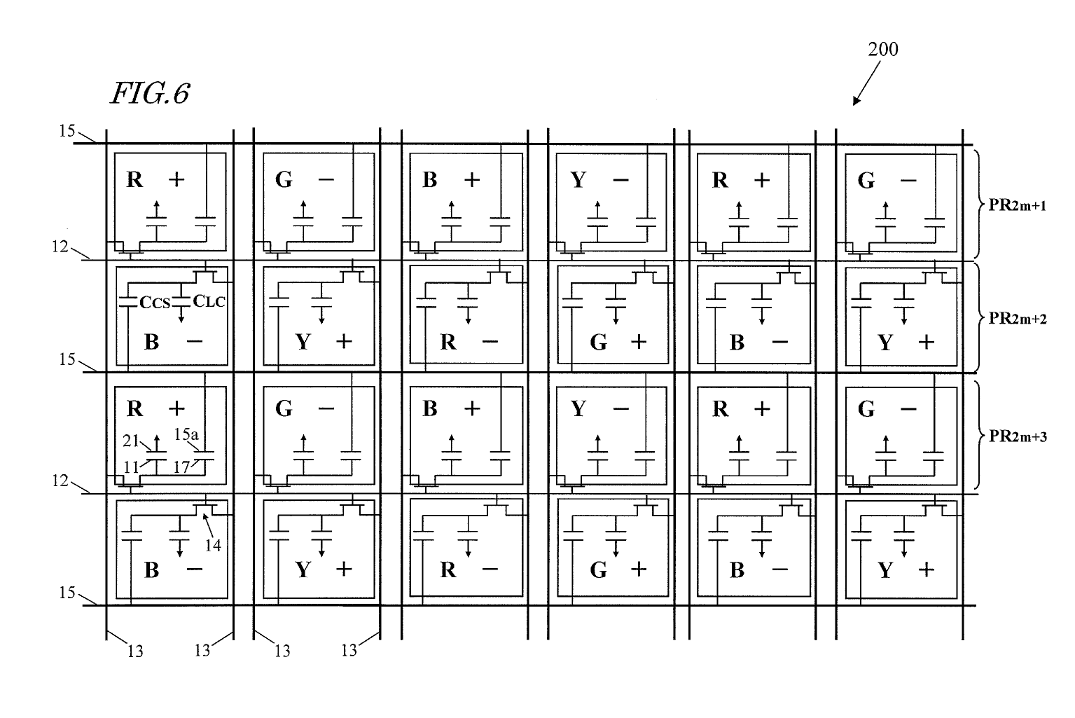

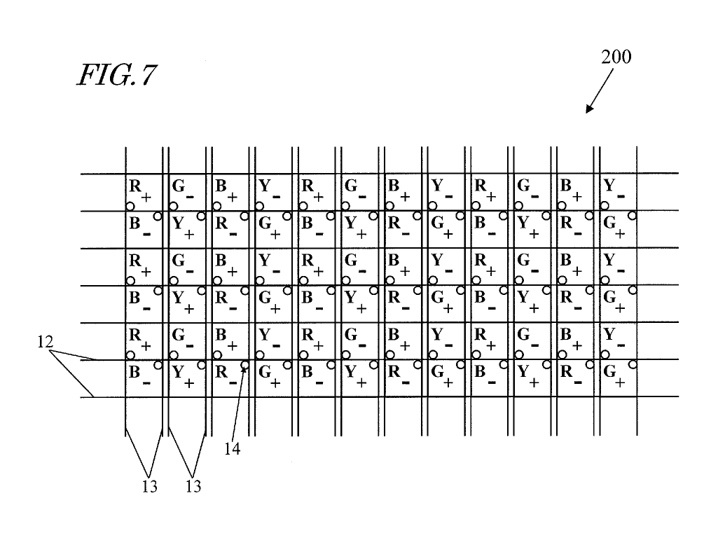

FIGS. 6 and 7 illustrate a liquid crystal display device 200 as a second embodiment of the present invention. FIG. 6 is an equivalent circuit diagram of twenty-four pixels that are arranged in six columns and four rows, while FIG. 7 shows the polarities of voltages applied to respective pixels of the liquid crystal display device 200 when those pixels are subjected to the dot inversion drive. The following description of this second embodiment will be focused on differences between the liquid crystal display devices 200 and 100 of this and first embodiments.

In the liquid crystal display device 100 shown in FIG. 3, a single scan line 12 is provided for each row of pixels, a single signal line 13 is provided for each column of pixels, and there are as many storage capacitor lines 15 as the scan lines 12 (i.e., a single storage capacitor line 15 is provided for each row of pixels). That is to say, if the plurality of pixels forms p rows of pixels and q column of pixels, then p scan lines 12, q signal lines 13 and p storage capacitor lines 15 are provided there.

On the other hand, in this liquid crystal display device 200, a single scan line 12 is provided for every two rows of pixels, two signal lines 13 are provided for each column of pixels, and the number of storage capacitor lines provided is larger by one than that of scan lines 12 provided as shown in FIGS. 6 and 7. That is to say, if the plurality of pixels forms p rows of pixels and q columns of pixels, (p/2) scan lines 12, 2q signal lines 13 and (p/2+1) storage capacitor lines 15 are provided here.

As the number of scan lines 12 provided is a half as large as in a general arrangement, the TFTs 14 of pixels that form two adjacent rows of pixels share a single scan line 12 in common. That is to say, if m is an integer that is equal to or greater than zero, the TFTs 14 of pixels that form a (2m+1)^{th} row of pixels PR₂ₘ₊₁ and the TFTs 14 of pixels that form a (2m+2)^{th} row of pixels PR₂ₘ₊₂ are electrically connected to the same scan line 12 and are supplied with the same scan signal.

Also, as the number of signal lines 13 provided is twice as large as in the general arrangement, the TFT 14 of a pixel that belong to an odd-numbered row in each column of pixels and the TFT 14 of another pixel that belong to an even-numbered row in the same column of pixel are electrically connected to mutually different signal lines 13. Specifically, in an odd-numbered column of pixels, the TFTs of red and blue pixels R and B are connected to two different signal lines 13. In an even-numbered column of pixels, the TFTs 14 of green and yellow pixels G and Y are connected to two different signal lines 13, too.

Furthermore, as the number of storage capacitor lines 15 provided is about a half as large as in the general arrangement, the storage capacitors C_{CS} of pixels that form two adjacent rows of pixels (except the first and last rows of pixels) share a single storage capacitor line 15 in common. That is to say, the pixels that form a (2m+2)^{th} row of pixels PR₂ₘ₊₂ and the pixels that form a (2m+3)^{th} row of pixels PR₂ₘ₊₃ are supplied with a voltage (i.e., a CS voltage) through the same storage capacitor line 15.

In the liquid crystal display device 200 of this embodiment, the storage capacitors C_{CS} of the pixels that form two adjacent rows of pixels share a single storage capacitor line 15 in common. That is why the same number of pixels to which a positive grayscale voltage is applied and pixels to which a negative grayscale voltage is applied are connected to each of the plurality of storage capacitor lines 15 (except the uppermost and lowermost ones). Consequently, the ripple voltage to be superposed on a CS voltage can be canceled and generation of horizontal shadows itself can be reduced.

In the first and second embodiments described above, red and blue pixels R and B are arranged to form odd-numbered columns of pixels and green and yellow pixels G and Y are arranged to form even-numbered columns of pixels. However, such a pixel arrangement does not always have to be adopted. Rather, any other pixel arrangement may also be adopted as long as two picture elements that are adjacent to each other in the row direction have vertically inverted pixel arrangements (i.e., inverted in the column direction).

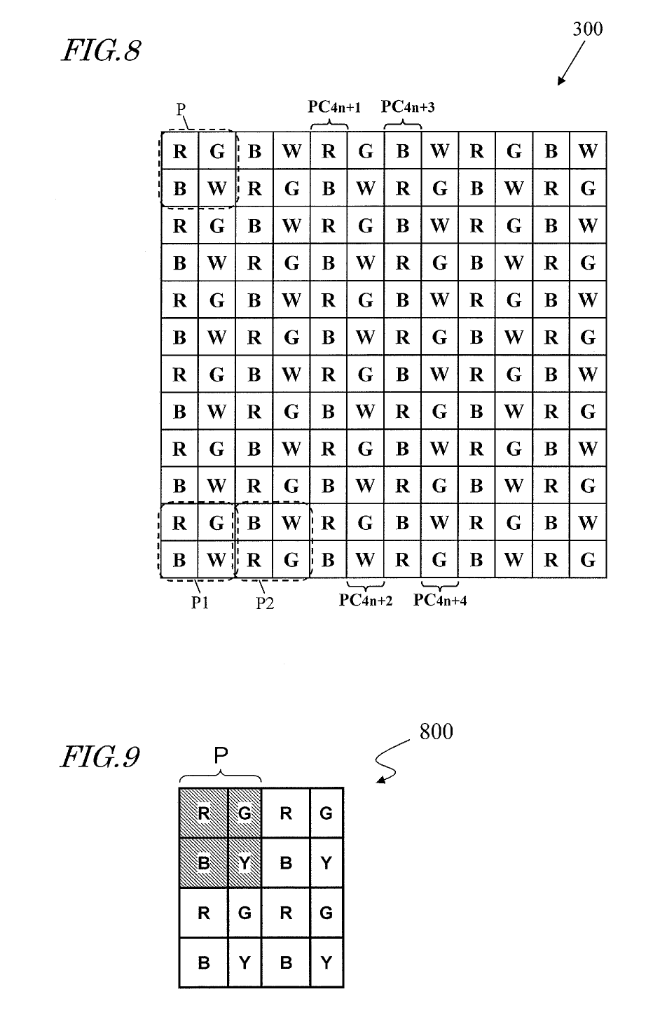

As for the respective kinds (i.e., the combination) of pixels that define a single picture element P, the combination described above is just an example, too. For example, each picture element P may be defined by either red, green, blue pixels R, G, and B and a cyan pixel representing the color cyan or red, green, and blue pixels R, G, and B and a magenta pixel representing the color magenta. Alternatively, each picture element P may also be defined by red, green, blue pixels R, G, and B and white pixel W representing the color white as in the liquid crystal display device 300 shown in FIG. 8. A colorless and transparent color filter (i.e., a color filter that transmits white light) is arranged in a region of the color filter layer of the counter substrate that is allocated to the white pixel W in the liquid crystal display device 300. In the liquid crystal display device 300, the color reproduction range cannot be broadened because the primary color added is the color white, but the overall display luminance of a single picture element P can be increased.

### INDUSTRIAL APPLICABILITY

According to the present invention, it is possible to prevent horizontal shadows, which are cast when a dot inversion drive operation is carried out, from debasing the display quality of a liquid crystal display device, of which each picture element is defined by four pixels. The present invention can be used effectively in a multi-primary-color liquid crystal display device.

### REFERENCE SIGNS LIST

10 active-matrix substrate
10a, 20a transparent substrate
11 pixel electrode
12 scan line
13 signal line
14 thin-film transistor (TFT)
15 storage capacitor line
15a storage capacitor counter electrode
16 gate insulating film
17 storage capacitor electrode
18 interlayer insulating film
19, 29 alignment film
20 counter substrate
21 counter electrode
30 liquid crystal layer
100, 200, 300 liquid crystal display device
P picture element
R red pixel
G green pixel
B blue pixel
Y yellow pixel
W white pixel

1. A liquid crystal display device comprising:
a plurality of pixels arranged in columns and rows to form a matrix pattern;
an active-matrix substrate that includes pixel electrodes that are provided for the respective pixels, switching elements that are electrically connected to the pixel electrodes, a plurality of scan lines that run in a row direction, and a plurality of signal lines that run in a column direction;
a counter substrate that faces the active-matrix substrate; and
a liquid crystal layer that is interposed between the active-matrix substrate and the counter substrate,
the plurality of pixels including first, second, third and fourth pixels that represent mutually different colors,
wherein the first and second pixels are arranged alternately in each odd-numbered column of pixels, and
wherein the third and fourth pixels are arranged alternately in each even-numbered column of pixels, and
wherein if n is an integer that is equal to or greater than zero,
the first and second pixels belong to odd- and even-numbered rows, respectively, in a (4n+1)^{th} column of pixels,
the third and fourth pixels belong to odd- and even-numbered rows, respectively, in a (4n+2)^{th} column of pixels,
the second and first pixels belong to odd- and even-numbered rows, respectively, in a (4n+3)^{th} column of pixels, and
the fourth and third pixels belong to odd- and even-numbered rows, respectively, in a (4n+4)^{th} column of pixels.

2. The liquid crystal display device of claim 1, wherein each of the first, second, third and fourth pixels is one of red, green, blue, and yellow pixels that represent the colors red, green, blue, and yellow, respectively.

3. The liquid crystal display device of claim 1, wherein the plurality of pixels forms p rows of pixels and q columns of pixels,
the plurality of scan lines is comprised of p scan lines,
the plurality of signal lines is comprised of q signal lines, and
the active-matrix substrate further includes p storage capacitor lines that run in the row direction.

4. The liquid crystal display device of claim 1,
wherein the plurality of pixels forms p rows of pixels and q columns of pixels,
the plurality of scan lines is comprised of (p/2) scan lines,
the plurality of signal lines is comprised of 2q signal lines, and
the active-matrix substrate further includes (p/2+1) storage capacitor lines that run in the row direction.

5. The liquid crystal display device of claim 4, wherein if m is an integer that is equal to or greater than zero,
the switching elements of pixels that form a (2m+1)^{th} row of pixels and the switching elements of pixels that form a (2m+2)^{th} row of pixels are electrically connected in common to the same scan line,
in each column of pixels, the switching element of each pixel that belongs to an odd-numbered row and the switching element of each pixel that belongs to an even-numbered row are electrically connected to mutually different signal lines, and
the pixel that belongs to the (2m+2)^{th} row of pixels and the pixel that belongs to the (2m+3)^{th} row of pixels are supplied with a voltage through the same storage capacitor line.

6. The liquid crystal display device of claim 1, wherein the plurality of pixels is driven by dot inversion drive method.
